(19) United States
(12) Patent Application Publication
(10) Pub. No.: US 2015/0007846 A1
(43) Pub. Date: Jan. 8, 2015

(54) Pretreatment Formulation and Method for Facilitating Removal of Gel Nail Polish and Gel Nail Strips

(71) Applicants: Anthony Weiburg, Staten Island, NY (US); Janet Weiburg, Staten Island, NY (US)

(72) Inventors: Anthony Weiburg, Staten Island, NY (US); Janet Weiburg, Staten Island, NY (US)

(21) Appl. No.: 14/492,029

(22) Filed: Sep. 21, 2014

Related U.S. Application Data
(60) Provisional application No. 62/039,457, filed on Aug. 20, 2014.

(51) Int. Cl. A61Q 3/02; A45D 29/00; A45D 29/17

(52) U.S. Cl. CPC A61Q 3/02; A45D 29/17; A45D 29/007
USPC 132/200

(57) ABSTRACT

A method for the application and removal of gel nail polish with an aqueous solution comprising the steps of applying a pre-application coating of an aqueous composition with a ceramide component to the nail to form an intermediate interposing layer on the nail. Thereafter, 1) a gel nail polish layer is applied on the intermediate layer and the gel nail polish layer or layers is light cured; 2) non-UV cured gel nail polish is applied to the intermediate layer; or 3) a gel nail strip is applied to the intermediate layer. The gel nail polish or gel nail strips is removed by soaking the nails with nail polish or gel nail strips in warm water optionally with soap for a sufficient period of time whereby the intermediate pre-application material is sufficiently softened for the physical scraping removal of the gel nail polish. The intermediate and nail polish layers or gel nail strips are removed by scraping.

### FIELD OF THE DISCLOSED TECHNOLOGY

This disclosed technology relates to formulations and methods for the removal of gel type nail polish and gel nail strips with an elevated temperature aqueous treatment.

### BACKGROUND

Gel nail polish is very difficult to remove according to common current methods. Gel nail polish, for purposes of this disclosure, refers to a layer of a synthetic nail which is made of a hard gel product: 1) which is hardened by curing under an ultraviolet or L.E.D. (light emitting diode) light, i.e., light cured hardening; 2) which is comprised of gel nail polish that does not require curing under an ultraviolet or L.E.D. (light emitting diode) light; or 3) which is comprised of gel strips that are applied to the nail. The resultant coating is a hard and shiny organic layer tightly bound to an underlying fingernail, requiring the use of an organic solvent and particularly acetone for the dissolution and removal of the nail polish.

Generally, the application of a gel nail polish requires that, a fingernail or toenail to be coated, be initially prepared or “prepped” in a manner similar to that of the application of wall paint. A base layer of a nail polish preparation is initially applied, and then color and finally a protective and glossy top coat are sequentially applied thereafter. The applied layers are cured by light (UV, LED and the like) to provide the hard, brightly colored and shiny nail polish appearance. However, with such effectively hard and durable application the resultant nail-bonded fingernail polish is very tightly bonded to the nail with an organic usually polymeric bond whereby removal thereof is difficult. Traditionally, such removal invariably requires soaking of the fingers or toes with gel nail polish or gel nail strips in a strong organic solvent solution and in particular an acetone solution for extended periods usually of at least about 20 minutes, in order to dissolve the adhering bond and/or dissolve the nail polish whereby it can then be readily removed. Cured gel fingernail or toenail polish, with a tighter bond, is thus difficult and time consuming to remove and, even worse, currently entails soaking of the fingernails or toenails and inevitably the fingers or toes in acetone, a toxic and carcinogenic chemical, which permeates the skin.

### SUMMARY OF THE DISCLOSED TECHNOLOGY

It is an object of the present disclosed technology to provide a method for the treatment of nails having been coated with the application of: 1) UV (or other light-based hardening treatment) hardened gel nail polish; 2) non-UV hardened gel nail polish; or 3) gel nail strips, whereby a simple elevated temperature aqueous treatment (i.e., warm water) is able to remove the nail polish without the necessity for use of noxious/toxic organic solvents such as acetone for such removal.

It is a further object of the present disclosed technology to provide such method with the application and use of an intermediate pretreatment forming layer which prevents direct adhesion of the gel nail polish with the nail and which intermediate layer and gel nail polish thereon or the bond between the nail and the intermediate layer is softenable and removable with only the use of an aqueous solution (i.e., warm water) maintained at elevated (define as “at least 5 degrees Celsius above ambient”) temperatures.

It is still yet another object of the present disclosed technology to utilize skin derived type ceramides (i.e., natural materials) and specific ceramides in the pretreatment coating layer, prior to the application of a gel nail polish and the hardening thereof with light, whereby the ceramides provide an interposition of an intermediary layer thereby preventing direct adhesion of the nail polish to the nail.

In a method for the application and removal of gel nail polish with an elevated temperature aqueous solution, the method proceeds by applying a pre-application coating of an aqueous composition to a nail to form an intermediate interposing layer on the nail before gel nail polish is applied thereto, wherein at least one of the interposing layer and bond formed between the nail and the interposing layer is softenable and releasable in an aqueous solution at a temperature above ambient temperature, applying at least one gel nail polish layer on the intermediate layer and light curing the at least one gel nail polish layer, and removing the nail polish, when the nail polish is to be removed or replaced, by soaking the nails in warm water optionally with soap for a sufficient period of time whereby the intermediate pre-application material is sufficiently softened and said bond is released, enabling the physical removal of the gel nail polish, and physically removing both the intermediate and nail polish layers.

### DETAILED DESCRIPTION OF EMBODIMENTS OF THE DISCLOSED TECHNOLOGY

The present disclosed technology comprises a method for the application and removal of gel nail polish with an elevated temperature aqueous or warm water solution comprising, at least some, or all of the steps of:
a) gently (with the use of relaxed muscles) filing the nail and applying cleaning alcohol to the nail for cleansing of the nail and allowing the alcohol to fully dry (evaporate);
b) applying a pre-application coating of an aqueous composition to the nail to form an intermediate interposing layer on the nail before gel nail polish is applied thereto, wherein the interposing layer and/or a bond formed between the nail and the interposing layer is softenable;
c) applying a gel nail polish layer onto the intermediate layer and light curing the gel nail polish layer;
d) removing the nail polish, when the nail polish is to be removed or replaced, by soaking the nails in warm water, which can also include soap, for a sufficient period of time whereby the intermediate pre-application material is sufficiently softened for the physical removal of the gel nail polish, such as by scraping;
e) scraping removal of both the intermediate and nail polish layers.

The “warm water”, as used herein, is at an elevated but not scalding temperature of above ambient and at least 40 degrees, or at least 45 degrees Celsius, such as 43 degrees Celsius (110 degrees Fahrenheit). The “sufficient period of time”, as used herein, is defined as ranging between 2 minutes to 4 minutes and is dependent on the physical characteristics, such as thickness, of the intermediate and nail polish layers. The gel nail polish is then removed with a nail scraper or wooden nail stick or other thin, hard object, such as another finger nail.

The intermediate layer can be formed by the application of a water/ceramide solution having an approximate composition of:
Water 91%
ceramide 3 ½%
ceramide 6-ii ½%

Ceramides are defined as materials coming from a family of way lipid molecules. A ceramide is composed of sphingosine and a fattty acid and ceramides are found in high concentrations within the cell membrane of cells. They are one of the component lipids that make up spingomyelin, one of the major lipids in the lipid bi-layer. Ceramide is a component of vernix caseosa, the waxy or cheese-like white substance found coating the skin of newborn human infants and is the main component of the stratum corneum of the epidermis layer of human skin. Together with cholesterol and saturated fatty acids, ceramide creates a water-impermeable, protective organ to prevent excessive water loss due to evaporation as well as a barrier against the entry of microorganisms.

The use of ceramides as a coating material on nails has been established, such as described in U.S. Pat. No. 6,099,826. This use has however been confined to a direct total coating use to improve the surface state of the nails. In particular, the outer surface of nails treated by application of a composition comprising a compound of ceramide type makes it possible to obtain a more uniform outer surface of the nail: the nail becomes smoother and shinier. In particular, the ceramide can improve the smooth and/or shiny nature of the outer surface of the nails. However the ceramides have not been generally used in conjunction with nail polish compositions whether of a hardenable gel type or otherwise

As described in the aforementioned patent, compounds of ceramide type form a uniform deposit by adsorption on the outer surface of the nail purportedly due to the fact that the ceramide diffuses and penetrates into the intercellular spaces of the nails, resulting in smoother and shinier nails. This type of bonding has been found to be more readily disruptable than the direct light cured gel nail polish bonding with the nail, and its disruption and removal from the nail is effected by simple soaking or treatment with soapy warm water at the aforementioned elevated temperatures.

In an embodiment of the disclosed technology, the nail polish is initially applied only after the pre-application coating being applied to the nail first such as in the form of a primer coating. Then the gel nail polish layers are applied to the nail surface. The gel nail polish layers are then dried and/or cured under ultraviolet light for a period of time, such as 60 seconds.

For removal of the nail polish, heat is applied, such as by soaking the nails in a warm water and soap solution. The gel nail polish is then removed by wiping the polish off with a cloth or other similar product since the bond between the primer coating and the nail has been softened and loosened so that it is no longer strongly bonded to the nail surface. This loosening is caused by the heat-activated ingredients and composition change between the primer layer and the gel nail polish/gel nail polish associated layers.

To remove the gel nails, which are applied on top of the pre-application layer, the user simply places fingers or toes, with the nail polish, into warm water, which may include some soap placed therein, (as defined above) and soaks for a period of time (as defined above).

Other ingredients which can be used or included in the water/ceramide solution, which provides the intermediate layer, include, by volume:
ceterearyl alcohol ½%
carborner ½%
PEG-3 distearoylamidoethylmonium methosulfate ½%
polysorbate 60 ½%
dipotassium phosphate ½%
cholesterol ½%
cetyl alcohol ½%
glycerine ½%
potassium phosphate ½%
propyl paraben ½%
ceramide 1 ½%
xanthan gum ½%
hydrogen peroxide ½%
phytosphingosine ½%
polyaxyl 40 stearate ½%
polysorbate 20 ½%
sodium lauroyl lactylate ½%

In an embodiment of the present disclosed technology, each ingredient listed above is used in an homogenous mixture. It should be understood that variations of up to 10%, by volume of any of the components and optional materials, are within the scope of the disclosed technology and that any combination of the ingredients can be used in addition to the basic water and ceramide solution components.

It is understood that the above description and specific examples are illustrative of the present disclosed technology with changes in materials and procedure being possible without departing from the scope of the disclosed technology as defined in the following claims.

We claim:

1. A method of applying and removing gel nail polish with an elevated temperature aqueous solution, comprising the steps of:
applying a pre-application coating of an aqueous composition to a nail to form an intermediate interposing layer on said nail before gel nail polish is applied thereto, wherein at least one of said interposing layer and bond formed between said nail and said interposing layer is softenable and releasable in an aqueous solution at a temperature above ambient temperature,
applying at least one gel nail polish layer on said intermediate layer and light curing the at least one gel nail polish layer;
removing said nail polish, when said nail polish is to be removed or replaced, by soaking said nails in warm water optionally with soap for a sufficient period of time whereby said intermediate pre-application material is sufficiently softened and said bond is released, enabling said physical removal of said gel nail polish; and
physically removing both said intermediate and nail polish layers.

2. The method of claim 1, wherein said aqueous composition comprises water and at least one ceramide.

3. The method of claim 2, wherein asid at least one ceramide comprises at least one of a ceramide 3 and ceramide 6-ii material and combination thereof.

4. The method of claim 3, wherein said aqueous solution comprises ½% by volume of ceramide 3, ½% by volume of ceramide 6-ii and 91% by volume of water.

5. The method of claim 3, wherein said at least one ceramide is present in said aqueous solution in volume amounts ranging from ½ to 10%.

6. The method of claim 1, wherein said warm water is maintained at a temperature of at least 40 degrees Celsius and a duration of said sufficient period of time ranges from 2 minutes to 4 minutes.

7. The method of claim 2, wherein said aqueous solution further comprises any or all of the materials selected from the group consisting of:
ceterearyl alcohol, carborner, PEG-3 distearoylamidoethylmonium methosulfate, polysorbate 60, dipotassium phosphate, cholesterol, cetyl alcohol, glycerine, potassium phosphate, propyl paraben, ceramide, xanthan gum, hydrogen peroxide, phytosphingosine, polyaxyl 40 stearate, polysorbate 20 sodium lauroyl lactylate, and mixtures thereof.

8. The method of claim 6, wherein said materials selected from said group each comprises ½ to 10% by volume of the aqueous solution.

9. The method of claim 1, wherein said nail polish is physically removed by scraping.

10. The method of claim 1, comprising additional steps, before said step of applying said per-application, of, in order:
filing said nail;
applying alcohol to said nail; and
allowing said alcohol to dry.

11. A method for the application and removal of gel nail polish with an elevated temperature aqueous solution comprising the steps of:
filing and applying alcohol to a nail;
applying a pre-application coating of an aqueous composition comprised of ½% by volume of ceramide 3, ½% by volume of ceramide 6-ii and 91% by volume of water, to said nail to form an intermediate interposing layer on said nail before gel nail polish is applied thereto, wherein at least one of said interposing layer and bond formed between said nail and said interposing layer is softenable and releasable in an aqueous solution at a temperature above ambient temperature,
applying at least one gel nail polish layer on said intermediate layer and light curing said at least one gel nail polish layer;
removing said nail polish, when said nail polish is to be removed or replaced, by soaking said nails in warm water with soap for a sufficient period of time whereby said intermediate pre-application material is sufficiently softened and said bond is released enabling said physical removal of said gel nail polish; and
physically removing both said intermediate and nail polish layers.
